(19) United States
(12) Patent Application Publication
(10) Pub. No.: US 2002/0128877 A1
(43) Pub. Date: Sep. 12, 2002

(54) Method, apparatus, and products for managing insurance

(76) Inventor: Donald N. Levit, Sugarland, TX (US)

Correspondence Address: J.M. (Mark) Gilbreth, GILBRETH & ASSOCIATES, P.C., P.O. Box 2428, Bellaire, TX, 77402-2428, US

(21) Appl. No.: 09/804,412

(22) Filed: Mar. 12, 2001

(51) Int. Cl. G06F 17/60

(52) U.S. Cl. 705/4

(57) ABSTRACT

The present invention relates to managing insurance programs. In another aspect, the present invention relates to managing insurance programs that provide an opportunity for a policy owner to be eligible for increasing benefits the greater the total amount of premiums paid by the policy owner. In even another aspect, the present invention relates to providing health insurance in which ownership of a portion of the premiums of a policy owner vests in the policy owner.

### BACKGROUND OF THE INVENTION

1. Field of the Invention

The present invention relates to methods, apparatus, and products for managing insurance programs. In another aspect, the present invention relates to methods, apparatus, and products for managing insurance programs that offer an opportunity for a policy owner to receive increasing benefits the greater the total amount of premiums paid by the policy owner. In even another aspect, the present invention relates to methods, apparatus, and products for providing health insurance in which ownership of a portion of the premiums vests in the policy owner.

2. Description of the Related Art

In 1999, 15.5 percent of the total United States population were without health insurance coverage during the entire year. That amounts to 42.6 million people. The proportion of uninsured children among all children in the United States in 1999 was 13.9 percent, or 10.0 million children.

Although medicaid insured 12.9 million poor people, 10.4 million poor people still had no health insurance in 1999, representing about one-third of the poor (32.4 percent).

Most of the people (62.8 percent) with health insurance in the United States were covered by a health insurance plan related to employment for some or all of 1999. The government also provides health insurance coverage. Among the entire population, 24.1 percent had government insurance, including medicare (13.2 percent), medicaid (10.2 percent), and military health care (3.1 percent).

The poor and near poor are less likely to have health insurance than the total population. Despite the medicaid program, 32.4 percent of the poor (10.4 million people) had no health insurance of any kind during 1999. This percentage is double the rate for the total population. The uninsured poor comprised 24.5 percent of all uninsured people

Medicaid was the most widespread type of health insurance among the poor, with 39.9 percent (12.9 million) of those in poverty covered by medicaid for some or all of 1999. Among the near poor (those with a family income greater than the poverty level but less than 125 percent of the poverty level), 25.7 percent (3.1 million people) lacked health insurance in 1999.

For families without employer-sponsored health insurance, but above the medicaid income eligibility criteria, the cost of health insurance can be prohibitive.

Even for laid off employees, the Consolidated Omnibus Budget Reconciliation Act (COBRA) program requires employers to extend their coverage usually for only 18 months at no more than 102% of actual costs. Following passage of the Health Insurance Portability And Accountability Act (HIPAA), those whose COBRA coverage ended could then convert their former group policy to their own individual policy. However, HIPAA coverage for an unemployed individual or their family is usually very expensive, since employers can charge at a rate substantially higer than allowed under COBRA. These high costs often make health insurance coverage unaffordable for people not covered by employer health insurance plans.

Also, under existing COBRA and HIPAA health insurance policies and under privately-purchased health insurance policies, policy holders who let their policies expire because of their inability to afford the premiums, forfeit all premiums previously paid in.

Individuals and families who have purchased health insurance directly and not through an employer face the risk of their insurance company cancelling for business reasons all policies in the state in which the insured resides, leaving the formerly insured without any health insurance.

Even if an individual or family has an individually-purchased health insurance policy and can afford the initial premium, as the covered adults get older, their premiums often increase because of their age. An older individual or family in this situation, that is below the age for eligibility for Medicare coverage, can then reach an insurance premium cost that is a great financial burden or unaffordable.

Many older individuals with Medicare coverage would also benefit from purchasing what is called “Medigap” coverage to cover medical cost not covered by Medicare. However, the cost of these “Medigap” policies are often prohibitive for older individuals, particularly if prescription drug coverage is provided.

One consequence of the higher costs of private health insurance with increasing age and the cancellability of private health insurance is that about 35 percent of families lose all or most of their life savings in the course of caring for a family member who is dying.

However, in spite of the above advancements, there still exists a need in the art for methods, apparatus, and products for implementing an insurance system.

In spite of the above advancements, there also still exists a need in the art for methods, apparatus, and products for implementing an insurance system that do not suffer from the disadvantages of the prior art apparatus, methods, and products.

There is another need in the art for methods, apparatus, and products for implementing an insurance system that allows an insured person to be vested in a substantial part of the premiums paid in by that individual and any appreciation of those funds over time.

There is even another need in the art for methods, apparatus, and products for an insurance system that provides the opportunity for health insurance coverage to increase the longer premiums are paid into the system.

These and other needs in the art will become apparent to those of skill in the art upon review of this specification, including its drawings and claims.

### SUMMARY OF THE INVENTION

It is an object of the present invention to provide for methods, apparatus, and products for implementing an insurance system.

It is another object of the present invention, to provide for methods, apparatus, and products for implementing an insurance system that do not suffer from the disadvantages of the prior art apparatus, methods, and products.

It is even another object of the present invention to provide for methods, apparatus, and products for implementing an insurance system that allows an insured person to own a substantial part of the premiums paid in by that individual and any appreciation of those funds over time.

It is still another object of the present invention to provide for methods, apparatus, and products for an insurance system that provides the opportunity for insurance coverage to increase the longer premiums are paid into the system.

These and other objects of the present invention will become apparent to those of skill in the art upon review of this specification, including its drawings and claims.

According to one embodiment of the present invention, there is provided a method of managing health insurance benefits for policy owners. The method includes accepting payment of a premium amount from the policy owner and then allocating the premium amount between an individual investment account, at least partially owned by the policy owner, and a general reserve fund.

According to another embodiment of the present invention, there is provided a computer system for managing health insurance benefits. The computer system includes a processor provided with instructions. Those instructions, when executed, instruct the processor to record a choice by a policy owner of a premium amount to be paid by the policy owner for health insurance and to enter a payment of the premium amount from the policy owner in a ledger. Following the instructions, the computer system then allocates the premium amount of the policy owner between an individual investment account and a general reserve fund and records ownership by the policy owner of a portion of the premium amount allocated to the individual investment account of the policy owner. Next, the computer system posts a claim from the policy owner for medical expenses caused by a medical event and processes the claim for payment. Processing the claim involves determining whether a policy owner has satisfied a waiting period prior to being eligible for use of the general reserve fund for payment of a portion of a processed claim. If the waiting period has been satisfied, the computer system provides for payment of a claim from the general reserve fund to the extent provided by a medical multiple factor. Finally, the computer system prints a check authorizing payment of the claim to the policy owner based on the processed claim.

According to even another embodiment of the present invention, there is provided computer-readable media in communication with a computer processor for managing health insurance benefits. The media have recorded on them instructions which when executed instruct the processor to perform a series of steps. Those steps include recording a choice by a policy owner of a premium amount to be paid by the policy owner for health insurance; entering a payment of the premium amount from the policy owner in a ledger; allocating the premium amount of the policy owner between an individual investment account and a general reserve fund and recording ownership by the policy owner of a portion of the premium amount allocated to the individual investment account of the policy owner; and posting a claim from the policy owner for medical expenses caused by a medical event. The media also have recorded instructions for processing the claim for payment, which includes determining whether the policy owner has satisfied a waiting period prior to being eligible for use of the general reserve fund. If the waiting period has been satisfied, the instructions on the media direct the computer to determine the amounts that need to be withdrawn from the general reserve fund, the non-vested portion of the pooled individual investment account, and an individual investment account for payment of a portion of a processed claim, to the extent provided by a medical multiple factor. Finally, the instructions recorded on the computer-readable media direct the computer system to print a check authorizing payment of the claim to the policy owner or one or more medical service providers based on the processed claim.

According to still another embodiment of the present invention, there is provided a computer-readable signal in communication with a computer system for managing health insurance benefits. The signal is provided with instructions which, when executed, instruct the computer to carry out a series of steps. The steps include recording a choice by a policy owner of a premium amount to be paid by the policy owner for health insurance and entering a payment of the premium amount from the policy owner in a ledger. The instructions in the signal also direct the computer to allocate the premium amount of the policy owner between an individual investment account and a general reserve fund and record ownership by the policy owner of a portion of the premium amount allocated to the individual investment account of the policy owner. The computer-readable signal also includes instructions for the computer to post a claim from the policy owner for medical expenses caused by a medical event and process the claim for payment. Processing the claim includes determining whether the policy owner has satisfied a waiting period prior to being eligible for use of the general reserve fund and the non-vested portion of the pooled investment account for payment of a portion of a processed claim, to the extent provided by a medical multiple factor. Finally, the instructions in the signal direct the computer to print a check authorizing payment of the claim to the policy owner based on the processed claim.

### BRIEF DESCRIPTION OF THE DRAWINGS

FIG. 1 is a block flow diagram showing financial management system 100.

FIG. 2 is a block flow diagram showing analytical system 200 for determining the front-end parameters for financial management system 100.

FIG. 3 is a block flow diagram showing the analytical system for determining back-end performance based on the front-end control parameters of FIG. 2.

### DETAILED DESCRIPTION OF THE INVENTION

The present invention comprises methods for managing a health insurance system that include accepting a policy owner's choice of a premium amount to be paid by the policy owner for health insurance, accepting payment of a premium amount from the policy owner, and allocating the premium amount between an individual investment account, at least partially owned by the policy owner, and a general reserve fund.

The apparatus for carrying out the methods of the present invention is preferably a computer system, along with necessary attendant hardware and software, configured to carry out the method of the present invention.

The products of the present invention include computer readable media comprising instructions, or a data signal embodied in a carrier wave comprising instructions, said instructions which when carried out by a computer will implement the method of the present invention.

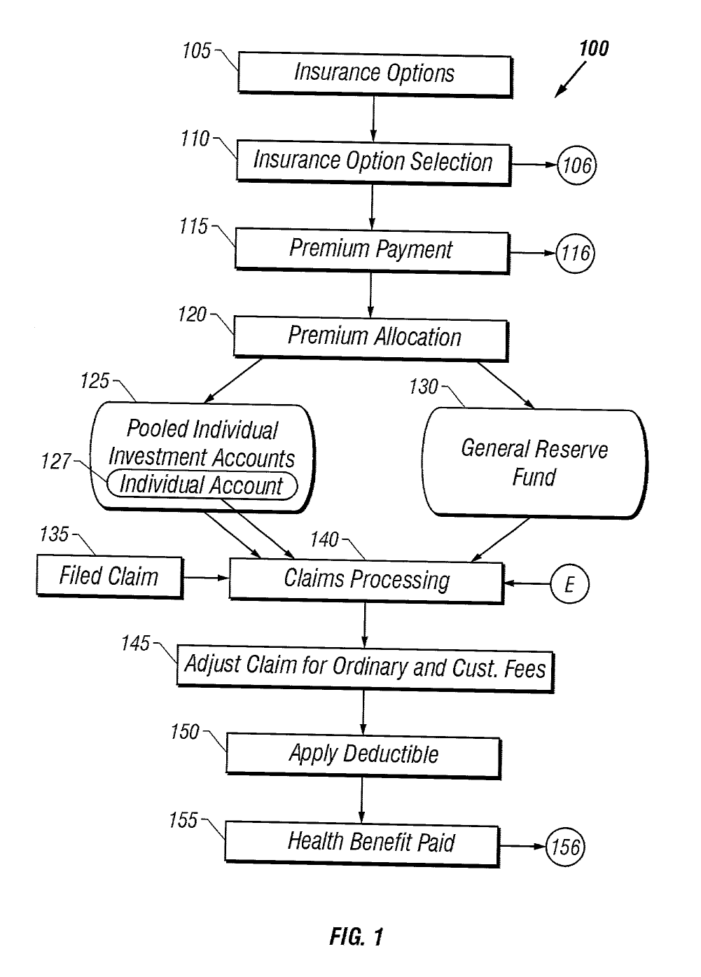

Referring first to FIG. 1, there is shown a block flow diagram of financial management system 100 in which step 105, insurance application, provides various health insurance options for selection by a prospective policy owner. A prospective policy owner may be offered a range of insurance options including but not limited to coverage, co-pay amounts, premium, and deductible. Coverage options may include, but are not limited to the number and status of people to be insured, e.g. primary, spouse, or child, and the medical and ancillary services insured. Co-pay options may range from no contribution to payment of a claim by a policy owner to the option of a policy owner paying more than 50% of a claim. A prospective policy owner may be offered a choice from among various premium amounts or requested to provide a desired premium amount, which may be further limited to a given range. Preferably for ease of management, a predetermined menu of premium amounts is offered. Of course, some prospective owners may wish to select insurance based on the coverage, rather than by selecting monthly premium amounts. Thus, various insurance coverage options may be presented as a choice between premiums, or a choice between coverage types. For example, insurance application step 105 may offer a choice between monthly premiums of $100, $200, $300, or $400, or between coverage with 5%, 10%, or 20% deductibles and certain listed maximum coverage amounts and listed exclusions (with the monthly premiums then calculated accordingly). Of course, any type of insurance plan options may be presented in insurance application step 105. The various health insurance options may be offered over a telephone menu system, over the Internet, through “dumb” terminals, through computers in communication with system 100 (i.e. via network connections or dial-in phone lines).

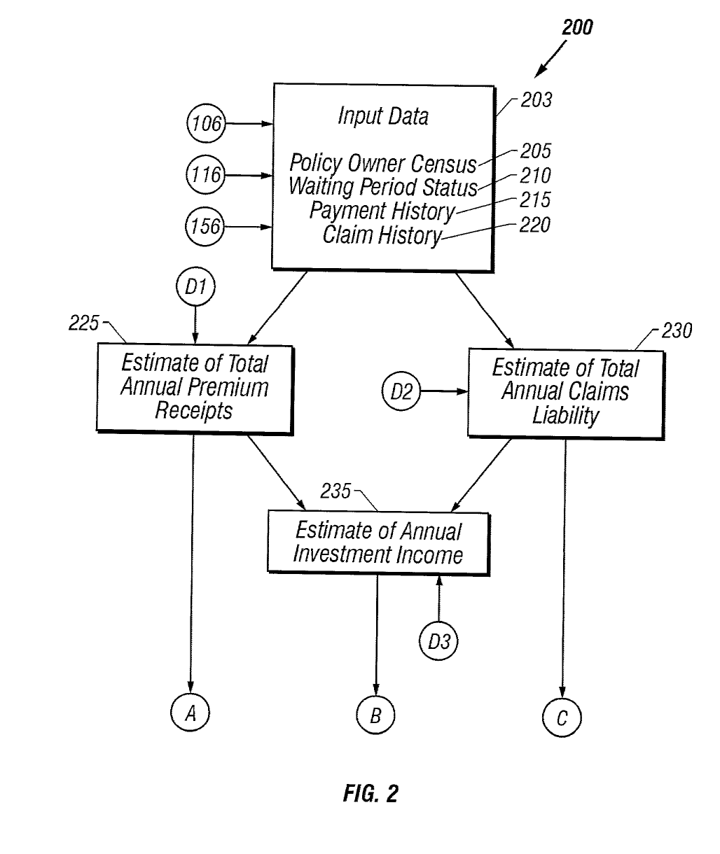

Next, in insurance option selection step 110, the prospective policy owner's selection is provided to financial management system 100. This selection may be input into system 100 by the prospective policy owner, or by a suitable user of system 100, such as an insurance agent, administrative clerk, and the like. The mode and manner of selection input shall depend upon the type of connection to system 100, i.e. phone, networked computer, Internet, etc. Any desired data about prospective policy owners is input at this time including name, date of birth, health history, age, sex, starting date of insurance coverage, and any other useful insurance parameters. These data are transferred via process flow step 106 to input data step 203 shown in FIG. 2.

Next in premium payment step 115, the amount of payment received from a policy owner is credited. Payment may be in any conventional manner such as cash, check, or credit card. Alternatively, automated systems to receive electronic fund transfers, credit card payments, or “e” money (i.e. via pre-arranged tranfers, touch-tone phone, Internet, or computer, may be utilized) which automated systems could be in direct communication with premium payment step 115. Payment history records are transferred from payment step 115 via process flow step 116 to input data step 203 shown in FIG. 2.

Next, premium allocation step 120 allocates the premium between a pooled individual investment account and a general reserve fund, according to an allocation percentage which is set forth in each policy owner's policy. At least a portion of premium payments by a policy owner is allocated to the pooled individual investment accounts and another portion is allocated to a general reserve fund. A preferred embodiment of this invention vests ownership to a policy owner of that part of a premium payment that is deposited into the pooled individual investment account, with vesting in all or part occurring according to a set schedule.

As a non-limiting example if a $400 premium payment is made by a policy owner, $300 is allocated to general reserve fund 130 and $100 is allocated to pooled individual investment accounts with 50% immediately vesting. Appropriate individuals, such as investment managers, will manage investment of premiums allocated to the pooled individual investment accounts and the general reserve fund.

The non-vested portion of the pooled investment account, the general reserve fund, and any earnings or gains on the vested and non-vested accounts may be used to contribute toward payment of medical claims by any policy owner through application of the medical multiplier and also to pay general operating expenses, including but not limited to rent, office equipment, and salaries.

Financial management system 100 includes databases, software and hardware to record and track premiums allocated to the pooled individual investment accounts and to the general reserve fund, as well as funds withdrawn from those accounts for payment of claims and other operating expenses. Pooled individual investment accounts module 125 keeps track of the portion of the pooled investment accounts, with module 127 keeping track of accounts vested in a particular policy owner is step 127. Finally, general reserve module 130 tracks deposits into, withdrawals from, and the balance of the general reserve fund. It should be understood that the values recorded in each of these tracking steps can be updated at suitable intervals, which can include real-time, hourly, daily, weekly, or monthly.

Claims processing step 140 receives information on claims filed by policy owners recorded in a filed claims database 135. Appropriate individuals will ensure that sufficient information is available to evaluate each claim, including information on doctors used, medical procedures performed, and prices charged. Claims processing step 140 also uses medical multiple factor 345 to calculate the amount of money that can be withdrawn from the individual investment account of the policy owner making the claim, from the non-vested pool of individual investment accounts, and from the general reserve fund to pay the claim filed by a policy owner. Filed claim database step 135 receives input data on medical events that form the basis of claims. Medical event data is obtained from either policy owners or medical service providers via, for example, the Internet, telefacsimile, digital telephone input devices, or mail.

Claim adjustment step 145, adjusts the claim for ordinary and customary fees, receives information on claims processed in claims processing step 140 and adjusts a claim amount downward or (optionally) upward if it respectively exceeds or falls below ordinary and customary fees for similar medical services performed in the same geographic area from which the claim was filed. Ordinary and customary fees are updated from time to time, for example, monthly, quarterly or annually for step 145 by appropriate individuals with access to financial management system 100 and access to national data sources on fees nationwide and internationally.

Following claim adjustment step 145, deductible application step 150 evaluates how much if any of a deductible has been applied to claims from the policy owner filing the claim in a designated time period or per medical event. Such a deductible transfers responsibility for payment of a set amount of claims costs in a set period of time, such as a calendar year, or per medical event, onto the policy owner.

A medical event may be defined as one primary illness with any secondary illnesses arising from the primary illness, or injuries arising from one accident or any secondary accidents arising from a primary accident.

If the deductible is not exceeded, a policy owner has the option of paying for the medical event only with funds vested to the policy owner from his or her individual investment account. The benefit of a high deductible is to preserve and increase individual balances in pooled investment accounts.

Non-limiting examples of a deductible amount, adjusted for inflation, would be about $500, preferably about $1,000, more preferably about $2,000, even more preferably about $3,000, yet more preferably about $4,000, even still more preferably about $5,000, and even yet more preferably $6,000, per medical event or per designated time period.

In the preferred embodiment, the preferred use of the present invention is to provide adequate insurance funds for major medical expenses which are more likely to occur as a policy owner approaches and enters old age.

Health benefit payment Step 155 receives information from appropriate previous steps to calculate the benefit to be paid in response to a claim and to authorize payment to the policy owner or to one or more health service providers.

Payment may be made in customary ways, such as by cash, check or electronic funds transfer. Step 155, benefit paid, authorizes or performs such payments.

Data on benefits paid to individual policy owners is transferred via process flow step 156 to input data step 203 shown in FIG. 2. It should be noted that data transferred in process flow steps 106, 116, and 156 may be either directly sent to data input step 203 or any or all of these data can be stored in a storage device and then sent to data input step 203 shown in FIG. 2.

In the present insurance industry, individuals approaching old age, prior to Medicare eligibility, may face substantially higher premiums than younger individuals. A preferred embodiment of the present invention offers a policy owner the opportunity to select a premium amount under insurance option selection step 110 within a specified range to maintain maximum coverage. Under this embodiment, a policy owner may also choose to stop paying premiums and retain access to the vested portion of his or her investment account for use in paying medical claims. Upon the death of a policy owner, remaining vested funds in a policy owner's share of the pooled individual investment accounts will be paid to heirs as a death benefit or otherwise disposed of or transferred as allowed by prevailing law.

Referring now to FIG. 2, there is illustrated with a block flow diagram analytical system 200 for determining the front-end parameters for financial management system 100. Analytical system 200 is maintained in a preferred embodiment on a computer system comprised of hardware and software. Shown are input data 203. These data are gathered from policy owners during their purchase of policies and from appropriate users that query insurance program managers and staff, via process flow steps 106, 116, and 156. Input data 203 consists of policy owner census 205 including the number and demographics of multiple policy holders, including but not limited to age, sex, and medical costs in their geographic location. Other input data include waiting period status 210 for each policy owner.

To accumulate funds in each vested individual investment account, a preferred embodiment of the present invention includes a set waiting period before a policy owner is eligible for receiving health insurance coverage from the general reserve fund and from the non-vested pooled investment account.

A non-limiting example would set the waiting period at about 6 months, preferably about 1 year, more preferably about 18 months, and even more preferably about 24 months. Using 24 months (two years) as an example of a waiting period, prior to the expiration of that two years, a policy owner would have access to only the vested portion of the investment account. It should be noted that the waiting period before insurance coverage can be a time interval of any length.

Further referring to FIG. 2, other input data 203 includes payment history 215 for each policy owner. In addition, input data 203 includes claims history 220 for every policy owner. Input data 203 is used to prepare an estimate of total annual premium receipts 225 from all policy owners. Input data 203 is also used to prepare an estimate of total annual claims liability 230.

Another datum needed for the front-end of financial management system 100 is an estimate of total annual investment income 235 which is based on estimated premium income from step 225 and from estimated withdrawals from investments from step 230, which is an estimate of total annual claims liability, and considering overhead and earnings or gains on funds.

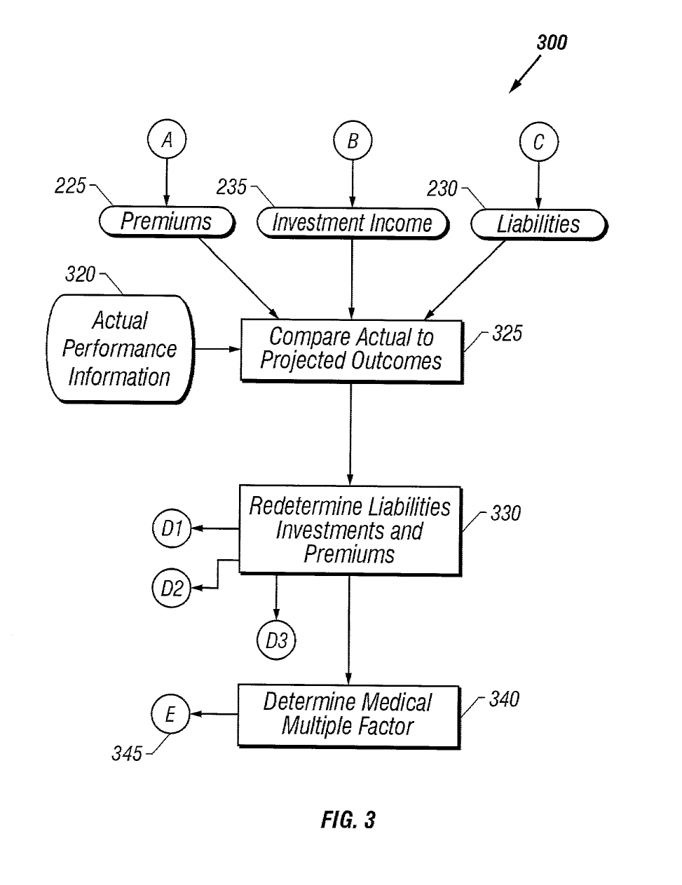

In addition to estimates of premium receipts 225 and claims liability 230, investment managers may review the total amount of investment holdings, performance of present investments, national economic outlook and market outlook, and evaluations of future performance of present investments and estimates of future performance of other investments that may be purchased while some present investments are sold. An estimate of total annual premium receipts 225 is used as output parameter A. An estimate of investment income 235 is used as output parameter B. And, an estimate of total annual claims liability 230 is used as output parameter C. Output parameters A, B, and C are transferred as input data to the analytical system shown in FIG. 3.

Referring now to FIG. 3, illustrated with a block flow diagram is the analytical system for determining back-end performance based on the front-end control parameters of FIG. 2. Shown are input A, estimate of total annual premium receipts 225, input B, estimate of total annual investment income 235, input C, estimate of total annual claims liability 230, and actual performance information 320, all used to compare actual to projected outcomes 325. Comparison 325 is then used to redetermine estimates of total annual premiums of all policy holders D1, total annual claims liability from all policy holders D2, and total annual investment income D3.

Redetermination of estimates of total annual premiums D1 is then sent to the front end analytical system shown in FIG. 2 as a revised estimate of total annual premiums 225. Likewise, the redetermined estimate of total annual claims liabilities D2 is sent to the analytical system shown in FIG. 2 as a revised estimate of total annual claims liability 230. Finally, the redetermined estimate of total annual investment income D3 is sent to the analytical system shown in FIG. 2 as a revised estimate of total annual investment income 235.

Further referring to FIG. 3, redetermination of liabilities and premiums 330 is used to determine 340 medical multiple factor 345 at appropriate intervals, including but not limited to annually.

In a preferred embodiment of the present invention, a non-limiting example of the use of medical multiple 345, is to assume that a policy owner has been paying premiums 115 regularly for 28 months, four months past a waiting period of 24 months. A policy owner has accumulated $7,000 in his or her tracking investment account 127. Medical multiple 345 is set in the third year at a value of 10. Thus, $70,000 is available to pay for a claim ($7,000×10=$70,000). A covered family member of the policy owner is hospitalized, and the total bill is $50,000. So, $5,000 is taken out of policy owner's tracking account 127 and goes directly to claims processing 140. claims processing step 140 authorizes payment of health benefit, step 155 totaling $50,000. Investment tracking account 127 of the policy owner now totals $2,000. If a claim of $100,000 is registered in filed claims database step 135, the health benefit of $70,000 is paid in step 155 and investment tracking account 127 shows a zero balance for that policy owner.

While the present invention has been illustrated mainly by reference to a health insurance system, it should be understood that the present invention finds utility with any sort of insurance system, including automobile, home, life, casualty, accident, etc.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

I claim:

1. A method of managing health insurance benefits for policy owners, the method comprising:
(a) accepting payment of a premium amount from the policy owner; and
(b) allocating the premium amount between an individual investment account, at least partially owned by the policy owner, and a general reserve fund.

2. The method of claim 1, wherein a claim is received from the policy owner for payment of medical expenses caused by a medical event.

3. The method of claim 2, wherein processing the claim for payment comprises determining amounts to be paid including use of a medical multiple factor.

4. The method of claim 3, wherein the claim is paid from the individual investment account and the general reserve account based on the processed claim.

5. The method of claim 3, wherein the medical multiple factor is determined by:
estimating totals for a plurality of policy owners of annual premium receipts, annual claims liability, and annual investment income,
wherein the investment income is a sum of income of both a pool of individual investment accounts and the general reserve fund;
estimating an average total amount of the general reserve fund including premium deposits without any withdrawals for a future year;
determining a total amount that can be withdrawn from the general reserve fund for payment of claims during the future year that maintains a reserve to pay at least a portion of operating expenses and unforseen claims expenses during the future year; and
determining a number to use as the medical multiple factor, which when multiplied by an estimated average balance of the individual investment accounts of policy holders likely to file claims in the future year, equals the total amount that can be withdrawn from the general reserve account and the pool of individual investment accounts.

6. The method of claim 3, wherein the medical multiple factor is redetermined by:
obtaining actual performance information for the total of the plurality of policy owners of annual premium receipts, annual claims liability, and annual investment income;
determining estimates of future annual premium receipts, annual claims liability, and annual investment income wherein the estimates factor in the actual performance information; and
redetermining an amount to use as the medical multiple factor which when multiplied by the estimated average balance of the individual investment accounts of policy holders likely to file claims in the future year, results in preserving a reserve of funds from which to pay claims and operating expenses in the future year.

7. The method of claim 6, wherein the estimates of total annual premium receipts, annual claims liability, and annual investment income are determined by:
obtaining data for the plurality of policy owners, the data comprising a policy owner census, waiting period status, payment history, and claims history;
determining a probable total number and size of premiums to be paid by existing and future policy owners for the future year based in part on premiums paid in a previous year;
determining an estimated total number and cost of medical claims to be submitted by existing and future policy owners for the future year based in part on claims filed in the previous year;
determining the estimate of annual investment income from types of investments and investment income from the previous year; and
determining the estimates of total annual premium receipts, annual claims liability, and annual investment income.

8. The method of claim 3, wherein processing the claim comprises:
determining whether the policy owner has satisfied a waiting period prior to being eligible for use of the general reserve fund for payment of a portion of a processed claim, to the extent provided by the medical multiple; and
if the waiting period has been satisfied, applying the medical multiple factor to the claim to calculate an amount of money available to withdraw from the individual investment account of the policy owner and from the general reserve fund for payment of the claim.

9. A method of managing health insurance benefits for policy owners, the method comprising:
(a) paying a health benefit from the individual investment account and the general reserve account based on the processed claim.

10. A computer system for managing health insurance benefits, comprising a processor provided with instructions, the instructions which when executed instruct the processor to:
a) record a choice by a policy owner of a premium amount to be paid by the policy owner for health insurance;
(b) enter a payment of the premium amount from the policy owner in a ledger;
(c) allocate the premium amount of the policy owner between an individual investment account and a general reserve fund and recording ownership by the policy owner of a portion of the premium amount allocated to the individual investment account of the policy owner;
(d) post a claim from the policy owner for medical expenses caused by a medical event;
(e) process the claim for payment, wherein processing the claim comprises determining whether the policy owner has satisfied a waiting period prior to being eligible for use of the general reserve fund for payment of a portion of a processed claim, to the extent provided by a medical multiple factor; and
(f) print a check authorizing payment of the claim to the policy owner based on the processed claim.

11. The apparatus of claim 10, wherein the instructions comprise steps for determining the medical multiple factor by:
estimating totals for a plurality of policy owners of annual premium receipts, annual claims liability, and annual investment income, wherein investment income is a sum of income of both a pool of the individual investment accounts and the general reserve fund; and
estimating an amount to use as the medical multiple factor which when multiplied by a balance of the individual investment accounts of policy holders likely to file claims in a future year, results in preserving a reserve of funds from which to pay claims and operating expenses.

12. The apparatus of claim 11 wherein the instructions comprise steps for redetermining the medical multiple factor by:
obtaining actual performance information for the total of the plurality of policy owners of annual premium receipts, annual claims liability, and annual investment income;
determining estimates of future annual premium receipts, annual claims liability, and annual investment income wherein the estimates factor in the actual performance information; and
redetermining an amount to use as the medical multiple factor which when multiplied by the balance of the individual investment accounts of policy holders likely to file claims in the future year, results in preserving a reserve of funds from which to pay claims and operating expenses in the future year.

13. Computer-readable media in communication with a computer processor for managing health insurance benefits, the media provided with instructions, the instructions which when executed instruct the processor to:
a) record a choice by a policy owner of a premium amount to be paid by the policy owner for health insurance;
(b) enter a payment of the premium amount from the policy owner in a ledger;
(c) allocate the premium amount of the policy owner between an individual investment account and a general reserve fund and record ownership by the policy owner of a portion of the premium amount allocated to the individual investment account of the policy owner;
(d) post a claim from the policy owner for medical expenses caused by a medical event;
(e) process the claim for payment, wherein processing the claim comprises determining whether the policy owner has satisfied a waiting period prior to being eligible for use of the general reserve fund for payment of a portion of a processed claim, to the extent provided by a medical multiple factor; and
(f) print a check authorizing payment of the claim based on the processed claim.

14. The computer-readable media of claim 13, wherein the instructions comprise steps for determining the medical multiple factor by:
estimating totals for a plurality of policy owners of annual premium receipts, annual claims liability, and annual investment income, wherein investment income is a sum of income of both a pool of the individual investment accounts and the general reserve fund; and
estimating an amount to use as the medical multiple factor which when multiplied by a balance of the individual investment accounts of policy holders likely to file claims in a future year, results in preserving a reserve of funds from which to pay claims and operating expenses.

15. The computer-readable media of claim 14, wherein the instructions comprise steps for redetermining the medical multiple factor by:
obtaining actual performance information for the total of the plurality of policy owners of annual premium receipts, annual claims liability, and annual investment income;
determining estimates of future annual premium receipts, annual claims liability, and annual investment income wherein the estimates factor in the actual performance information; and
redetermining an amount to use as the medical multiple factor which when multiplied by the balance of the individual investment accounts of policy holders likely to file claims in the future year, results in preserving a reserve of funds from which to pay claims and operating expenses in the future year.

16. A computer-readable signal in communication with a computer processor for managing health insurance benefits, the signal provided with instructions, the instructions which when executed instruct the processor to:
a) record a choice by a policy owner of a premium amount to be paid by the policy owner for health insurance;
(b) enter a payment of the premium amount from the policy owner in a ledger;
(c) allocate the premium amount of the policy owner between an individual investment account and a general reserve fund and recording ownership by the policy owner of a portion of the premium amount allocated to the individual investment account of the policy owner;
(d) post a claim from the policy owner for medical expenses caused by a medical event;
(e) process the claim for payment, wherein processing the claim comprises determining whether the policy owner has satisfied a waiting period prior to being eligible for use of the general reserve fund for payment of a portion of a processed claim, to the extent provided by a medical multiple factor; and
(f) print a check authorizing payment of the claim to the policy owner based on the processed claim.

17. The computer-readable signal of claim 16, wherein the instructions comprise steps for determining the medical multiple factor by:
estimating totals for a plurality of policy owners of annual premium receipts, annual claims liability, and annual investment income, wherein investment income is a sum of income of both a pool of the individual investment accounts and the general reserve fund; and
estimating an amount to use as the medical multiple factor which when multiplied by a balance of the individual investment accounts of policy holders likely to file claims in a future year, results in preserving a reserve of funds from which to pay claims and operating expenses.

18. The computer readable signal of claim 17, wherein the instructions comprise steps for redetermining the medical multiple factor by:
obtaining actual performance information for the total of the plurality of policy owners of annual premium receipts, annual claims liability, and annual investment income;
determining estimates of future annual premium receipts, annual claims liability, and annual investment income wherein the estimates factor in the actual performance information; and
redetermining an amount to use as the medical multiple factor which when multiplied by the balance of the individual investment accounts of policy holders likely to file claims in the future year, results in preserving a reserve of funds from which to pay claims and operating expenses in the future year.
